(19) United States
(12) Patent Application Publication
(10) Pub. No.: US 2014/0205104 A1
(43) Pub. Date: Jul. 24, 2014

(54) INFORMATION PROCESSING APPARATUS, INFORMATION PROCESSING METHOD, AND PROGRAM

(71) Applicant: SONY CORPORATION, Tokyo (JP)

(72) Inventors: YUKI ISHIKAWA, Nagano (JP); YIPING SHI, Nagano (JP); HIDEKAZU KAMON, Nagano (JP)

(73) Assignee: SONY CORPORATION, Tokyo (JP)

(21) Appl. No.: 14/151,405

(22) Filed: Jan. 9, 2014

(30) Foreign Application Priority Data
Jan. 22, 2013 (JP) 2013-009044

(51) Int. Cl. H04R 29/00

(52) U.S. Cl. CPC H04R 29/00
USPC 381/58

(57) ABSTRACT

There is provided an information processing apparatus including a detection unit configured to detect a usage state of a sound output unit, and a signal processing unit configured to tune sound signals to be outputted to the sound output unit, based on the usage state of the sound output unit.

### CROSS REFERENCE TO RELATED APPLICATIONS

This application claims the benefit of Japanese Priority Patent Application JP 2013-009044 filed Jan. 22, 2013, the entire contents of which are incorporated herein by reference.

### BACKGROUND

The present disclosure relates to an information processing apparatus, an information processing method, and a program.

JP 2003-111200A discloses a technology of tuning an audio signal for adjusting a position from which audio according to an audio signal is heard.

### SUMMARY

However, with the technology described in JP 2003-111200A, it is not possible to detect a usage state of a speaker, and thus a sound field and a sound quality of the audio vary depending on the usage state of the speaker. For this reason, there is a demand for a technology enabling output of audio having a sound field and a sound quality which are more stable.

According to an embodiment of the present disclosure, there is provided an information processing apparatus including a detection unit configured to detect a usage state of a sound output unit, and a signal processing unit configured to tune sound signals to be outputted to the sound output unit, based on the usage state of the sound output unit.

According to an embodiment of the present disclosure, there is provided an information processing method including detecting a usage state of a sound output unit, and tuning a sound signal to be outputted to the sound output unit, based on the usage state of the sound output unit.

According to an embodiment of the present disclosure, there is provided a program causing a computer to implement a detection function of detecting a usage state of a sound output unit, and a signal processing function of tuning the sound signal to be outputted to the sound output unit, based on the usage state of the sound output unit.

According to an embodiment of the present disclosure, the information processing apparatus can tune the sound signal according to the usage state of the sound output unit.

According to an embodiment of the present disclosure described above, it is possible to tune the sound signal according to the usage state of the sound output unit, and thus possible to output sound (audio) having a sound field and a sound quality which are more stable.

### BRIEF DESCRIPTION OF THE DRAWINGS

FIG. 1 is a block diagram illustrating a configuration of a display device (an information processing apparatus) according to an embodiment of the present disclosure;

FIG. 2 is an explanatory diagram illustrating a side surface of the display device and an example of an assumed looking and listening point;

FIG. 3 is a graph showing a correspondence relationship between a frequency and a sound pressure;

FIG. 4 is a graph showing impulse responses of a speaker (sound output unit) exhibited on a time basis;

FIG. 5 is an explanatory diagram for explaining a sound field and a sound quality which are constant regardless of a placement angle (usage state) of the speaker;

FIG. 6 is an explanatory diagram for explaining a sound field and a sound quality which are constant regardless of a placement angle (usage state) of the speaker;

FIG. 7 is an explanatory diagram for explaining a sound field and a sound quality which are constant regardless of a placement angle (usage state) of the speaker;

FIG. 8 is a timing chart for explaining an example of audio switching processing (sound switching processing);

FIG. 9 is a timing chart for explaining an example of audio switching processing;

FIG. 10 is a timing chart for explaining an example of audio switching processing;

FIG. 11 is a flowchart illustrating steps of processing performed by the display device;

FIG. 12 is a flowchart illustrating steps of processing performed by the display device;

FIG. 13 is a flowchart illustrating steps of processing performed by the display device;

FIG. 14 is a flowchart illustrating steps of processing performed by the display device;

FIG. 15 is a side diagram illustrating how a human voice is heard from a display device according to a background art;

FIG. 16 is a side diagram illustrating how a human voice is heard from a display device according to a background art;

FIG. 17 is a side diagram illustrating how a human voice is heard from a display device according to a background art; and

FIG. 18 is a side diagram illustrating how a human voice is heard from a display device according to a background art.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The descriptions will be given in the following order.

1. Study on Background Arts

2. Display Device Configuration

3. Steps of Processing by Display Device

<1. Study on Background Arts>

The present inventors have studied background arts of an embodiment of the present disclosure and thereby have conceived a display device 10 according to the present embodiment. Hence, a description is firstly given of the background arts studied by the present inventors.

A display device equipped with a speaker has a characteristic that a sound field and a sound quality vary depending on the position of a hole surface (surface through which audio is outputted) of the speaker (that is, a position of equipping the speaker and a position of holes). In particular, when the hole surface of the speaker is not provided in front of a front surface of the display device, the position of the hole surface considerably influences the sound field and quality.

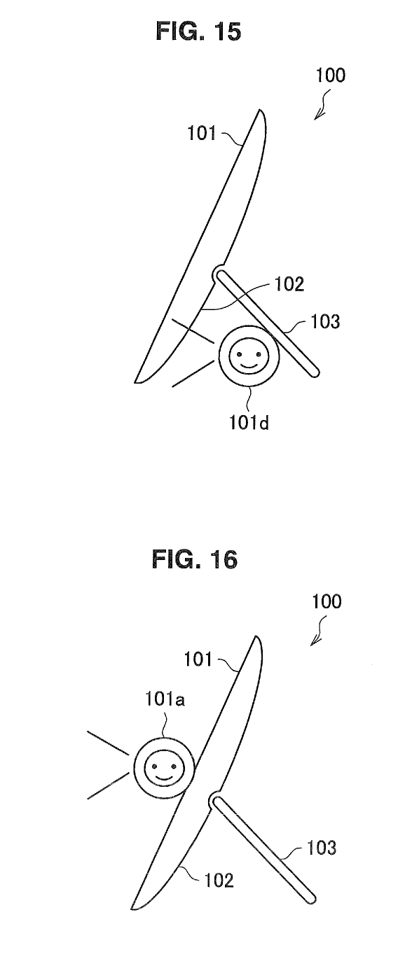

A specific example is described based on FIG. 15. FIG. 15 illustrates a display device 100. The display device 100 includes a display 101, a speaker 102, and a supporting portion 103. A hole surface of the speaker 102 is provided in a lower part of a rear surface of the display 101. The supporting portion 103 fixes the display 101 (and the speaker 102) at a desired placement angle (usage state). Here, a placement angle of the display 101 is an angle between a display surface of the display 101 and a surface on which the display device 100 is placed (that is, a placement surface). A placement angle of the speaker 102 is an angle between the hole surface of the speaker 102 and the placement surface. The same holds true for the display device 100 and the display device 10 according to an embodiment of the present disclosure in the following description.

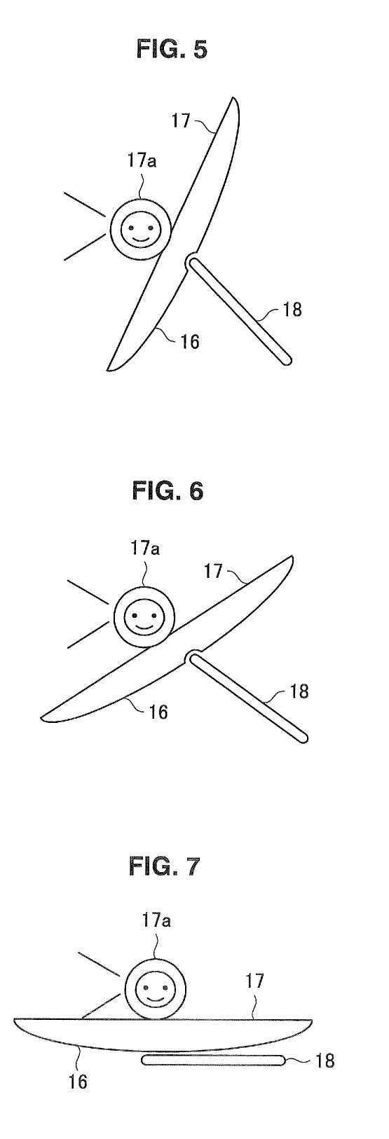

In the example in FIG. 15, when the speaker 102 outputs a human voice as audio, the human voice is heard from a region 101d behind the display 101. In other words, the human voice outputted from the speaker 102 generates a sound field, and this sound field causes a user to feel that the human voice comes from behind the display 101. As described above, FIG. 15 illustrates the position from which the human voice is heard, as an example of the sound field. Note that each of FIGS. 16 to 18 and FIGS. 5 to 7 also illustrates a position from which a human voice is heard, as an example of a sound field.

In the example in FIG. 15, the user strongly feels the position unnatural from which the audio is heard. Hence, there is proposed a technology by which tuning is performed based on a placement angle made with a predetermined point (for example, a placement angle in FIG. 16). With this technology, the placement angle of the display 101 is fixed to be made with a predetermined point, and a human voice is outputted from the speaker 102. Then, a sound field and a sound quality at an assumed looking and listening point (a position where the user is anticipated to look at the display 101) are detected. The assumed looking and listening point will be described in detail later. Then, a tuning parameter (correction parameter) is set so that a human voice can be heard from a central portion 101a of the display 101. Here, the tuning parameter is a parameter for setting the sound field and quality at the assumed looking and listening point. Then, the display device 100 tunes audio signals based on the tuning parameter and outputs the tuned audio signals to the speaker 102. The speaker 102 outputs audio corresponding to the audio signals.

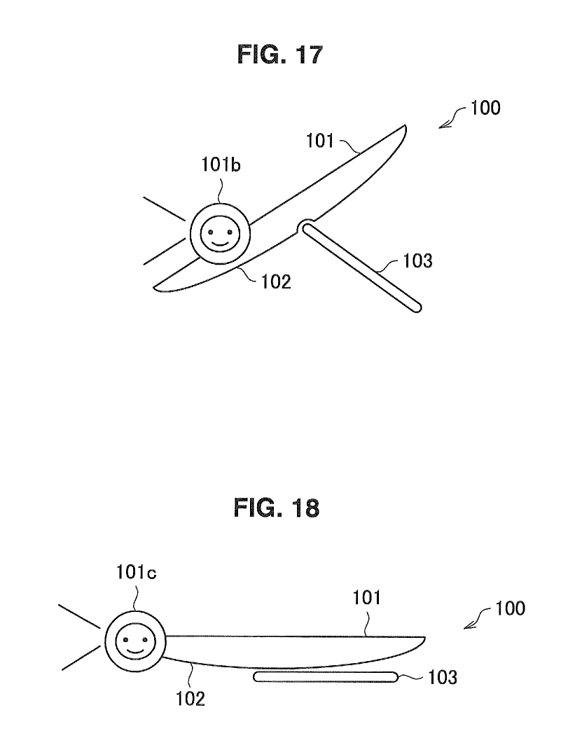

With the technology, the human voice is heard from the central portion 101a of the display 101, when the placement angle of the display 101 coincides with the angle illustrated in FIG. 16. However, the tuning parameter in the technology does not support the other placement angles. Accordingly, when the placement angle is, for example, any of angles illustrated in FIGS. 17 and 18, the sound field changes. Consequently, the human voice is heard from another position. For example, the human voice is heard from a position 101b lower than the central portion 101a in the case of FIG. 17, and is heard from a low end portion 101c of the display 101 in the case of FIG. 18. Thus, also with this technology, the user still feels the position unnatural from which the audio is heard.

For these reasons, there is a demand for a technology of automatically detecting a placement angle of a speaker and tuning audio signals accordingly. The present inventors have earnestly studied such a technology and have consequently conceived the display device 10 according to an embodiment of the present disclosure. Hereinafter, the present embodiment will be described in detail.

<2. Display Device Configuration>

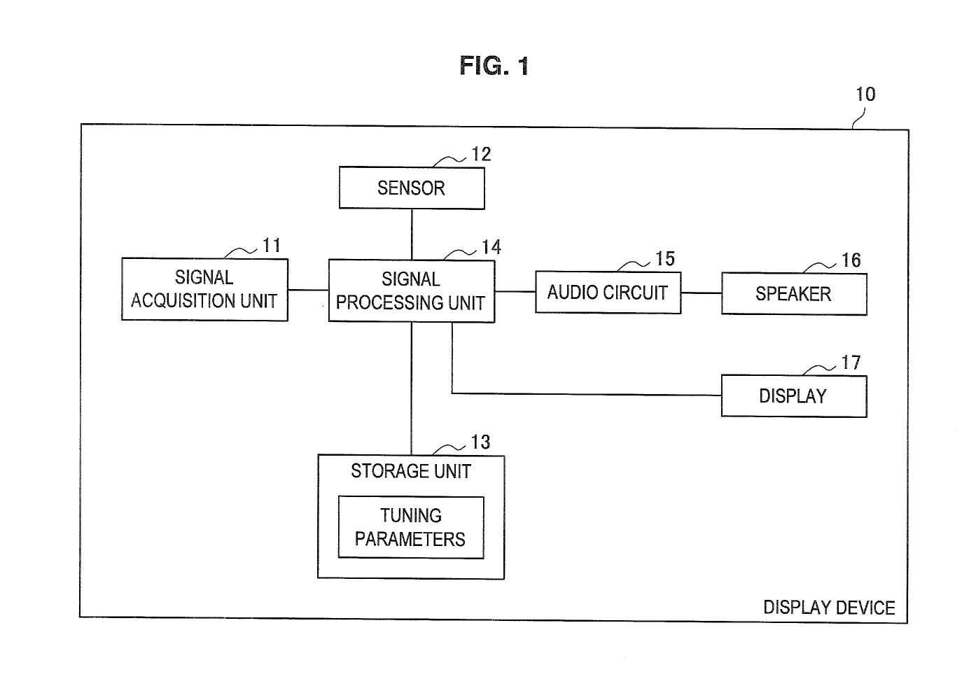

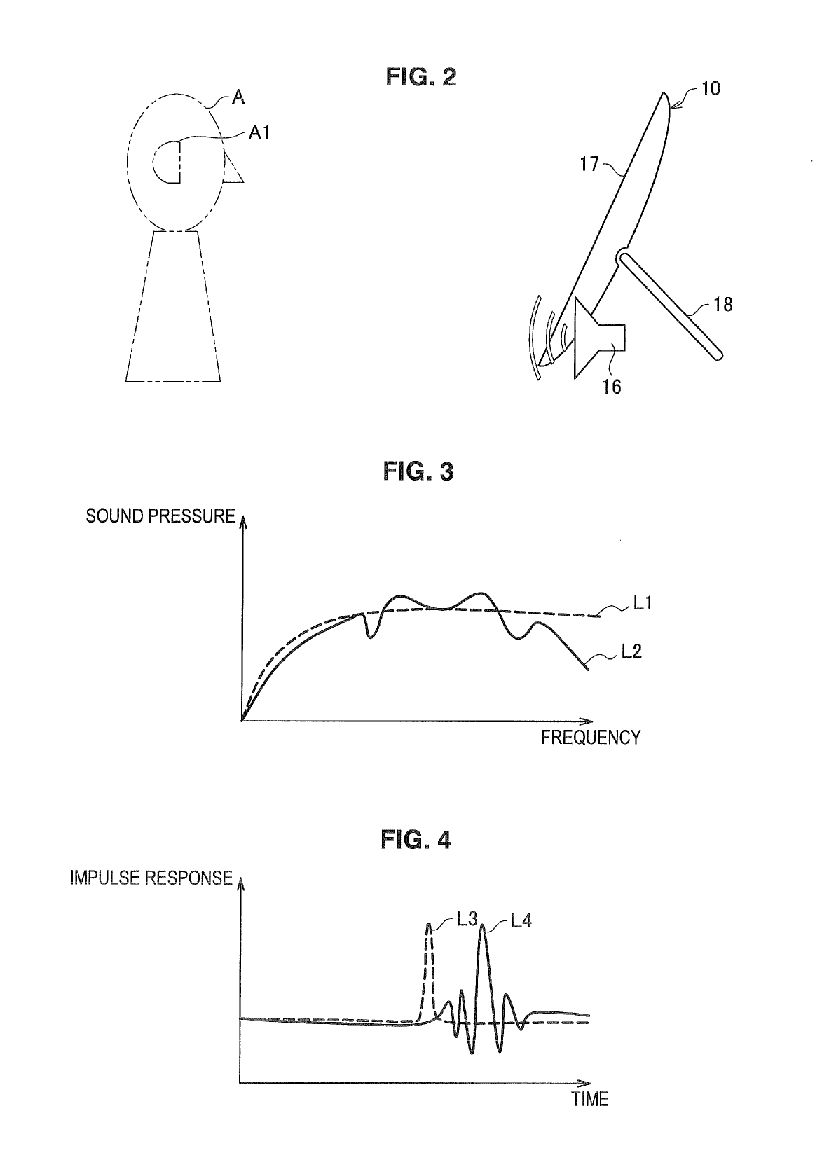

Next, a configuration of the display device 10 according to an embodiment of the present disclosure will be described based on FIGS. 1 and 2. Note that the present embodiment describes an example in which the information processing apparatus according to an embodiment of the present disclosure is a display device, but it goes without saying that the information processing apparatus is not limited to the display device. For example, the information processing apparatus may be a speaker alone or a speaker built in audio equipment. In other words, the information processing apparatus according to an embodiment of the present disclosure may be any component, as long as the component includes an element configured to block sound outputted from the speaker. FIG. 2 schematically illustrates a speaker 16 outside a display 17 for easy understanding, but the speaker 16 is actually provided in a lower part of a rear surface of the display 17.

As illustrated in FIGS. 1 and 2, the display device 10 includes a signal acquisition unit 11, a sensor 12 (detection unit), a storage unit 13, a signal processing unit 14, an audio circuit 15, the speaker 16, the display 17, and a supporting unit 18. Note that the display device 10 has a hardware configuration including a CPU (Central Processing Unit), a ROM (Read Only Memory), a RAM (Random Access Memory), an external storage device such as a hard disk, various sensors, the display, the speaker, a communication device, and the like. The ROM stores a program necessary for implementing functions of the display device 10, particularly, functions of the signal acquisition unit 11 and the signal processing unit 14. The CPU reads and executes the program stored in the ROM. Thus, the signal acquisition unit 11, the sensor 12, the storage unit 13, the signal processing unit 14, the audio circuit 15, the speaker 16, the display 17, and the supporting unit 18 are implemented by using the hardware configuration.

The signal acquisition unit 11 acquires an audio signal and outputs the audio signal to the signal processing unit 14. The signal acquisition unit 11 may acquire the audio signal through a communication network or the like or from the storage unit 13. The audio signal includes a wide variety of information (such as the type of a sound source, a sound pressure, and a frequency) on a sound wave. Here, the sound source refers to a source from which audio converted into an audio signal is outputted, such as a person or a musical instrument. The signal acquisition unit 11 acquires an image signal in the same manner as for the audio signal and outputs the image signal to the signal processing unit 14.

The sensor 12 detects a placement angle (usage state) of the speaker 16 and outputs a detection signal indicating a detection result to the signal processing unit 14. Specifically, as illustrated in FIG. 2, the speaker 16 is provided in the lower part of the rear surface of the display 17, and the supporting unit 18 can fix the display 17 and the speaker 16 at desired placement angles, respectively. The sensor 12 detects the placement angle of the speaker 16. Examples of the sensor 12 include an acceleration sensor, a magnetic field sensor, and an angular sensor.

The storage unit 13 stores therein tuning parameters for respective parameter regions in addition to the variety of information necessary for implementing the functions of the display device 10 (for example, the aforementioned program). Specifically, in an embodiment of the present disclosure, the placement angle of the speaker 16 is classified into the plurality of parameter regions, and the tuning parameters are set for the respective parameter regions. The parameter regions are each expressed as [Xk, X(k+1)], for example. The parameter region [Xk, X(k+1)] means a parameter region of the placement angle which is equal to or larger than Xk and is smaller than X(k+1). Each tuning parameter corresponding to the parameter region [Xk, X(k+1)] is expressed as a “Parameter k”. The larger the number of the parameter regions, the higher the tuning accuracy is. The storage unit 13 may be incorporated into the signal processing unit 14 or may be an external storage device.

Each tuning parameter is a parameter for tuning (setting) a sound field and a sound quality of audio. More specifically, the tuning parameter is a parameter obtained by combining: a frequency tuning parameter for tuning a frequency characteristics of the audio; a phase tuning parameter for tuning a phase characteristic of the audio; an inverse function of a transfer function of an area from a speaker to an assumed looking and listening point; and the like. The tuning parameter is adjusted so that the same sound field and the same sound quality can be reproduced for audio from the same sound source regardless of the parameter region.

(Method for Setting Tuning Parameter)

Here, a method for setting a tuning parameter will be described based on FIGS. 2 to 4. Firstly, an assumed looking and listening point area A is set. The assumed looking and listening point area A is an area in which the user is assumed to listen to audio outputted from the speaker 16 and look at an image displayed on the display 17. Then, the audio is actually outputted from the speaker 16, while the frequency characteristic and the phase characteristic of the audio are measured in ear portions A1 of the assumed looking and listening point area A.

FIG. 3 illustrates an example of the frequency characteristic. As illustrated in FIG. 3, the frequency characteristic shows a correspondence relationship between a frequency and a sound pressure of audio. A dashed line L1 in the graph represents an example of a desired value of the frequency characteristic in each ear portion A1, and a solid line L2 in the graph represents actual values of the frequency characteristic in the ear portion A1. As shown by the solid line L2 in the graph, the actual values of the frequency characteristic deviate from the desired value due to the characteristics of the speaker 16 itself, an environment of the area between the speaker 16 and the assumed looking and listening point (for example, sound wave reflection caused by a wall and a floor), and the like. Hence, frequency tuning parameters are set so that the actual values can be close to the desired value.

FIG. 4 illustrates an example of the phase characteristic. As illustrated in FIG. 4, the phase characteristic shows the degree of an audio phase lag. The phase characteristic is measured as a lag of response to an impulse signal. In other words, the phase characteristic is measured, for example, as impulse responses (sound pressures) exhibited on a time basis. A dashed line L3 in the graph represents an example of a desired value of the phase characteristic in each ear portion A1, and a solid line L4 in the graph represents actual values of the phase characteristic at the ear portion A1. As shown by the solid line L4 in the graph, even if an impulse signal is inputted, it is not possible for the speaker 16 to immediately output audio corresponding to the impulse signal. In addition, before and after the speaker 16 outputs the audio corresponding to the impulse signal, rising and lowering of the audio are observed. For these reasons, the actual values of the phase characteristic deviate from the desired value. Hence, phase tuning parameters are set so that the actual values can be close to the desired value. By tuning the frequency characteristic and the phase characteristic of the audio, the sound field and quality of the audio are tuned. In other words, not only the frequency characteristic but also the phase characteristic of the audio are tuned (corrected) in the present embodiment, and thus the sound field and quality of the audio can be tuned more appropriately.

The transfer function is a function which shows how the audio outputted from the speaker 16 is transferred to the ear portion A1. In other words, a waveform obtained by multiplying a waveform of the audio outputted from the speaker 16 by the transfer function substantially coincides with a waveform of the audio observed in the ear portion A1. Accordingly, when the audio signal is tuned in advance based on the inverse function of the transfer function, the audio corresponding to the audio signal is observed in the ear portion A1.

Each tuning parameter is obtained by combining the aforementioned parameters, the transfer function, and the like, and further by flavoring (tuning) the result according to the placement angle of the speaker 16. The tuning parameter is shared by different sound sources, but is adjusted so as to provide a sound field and a sound quality which vary with the sound sources. Specifically, the tuning parameter is adjusted to reproduce position information (sound field information) on each sound source in an audio recording scene (such as a place, a state, or the like where the audio is recorded). Generally in the case of a music source, a person is frequently located in the center of the audio recording scene, and thus the tuning parameter is frequently adjusted so that a human voice can be heard from a central portion 17a of the display 17 (see FIGS. 5 to 7). However, when a person is located at a position shifted from the center of the audio recording scene (for example, on the left side viewed from a sound collector) or when the recording is performed to result in such shifting, the tuning parameter is adjusted so that such shifting can be reflected. For example, the tuning parameter is adjusted so that the human voice can be heard from the position shifted leftward from the central portion 17a of the display 17. The same holds true for other sound sources. Meanwhile, when sounds are outputted together with video, the tuning parameter is adjusted so that the sounds from sound sources which are a musical instrument and a person can be heard from the respective positions of the musical instrument and the person. For example, when a sound source is a person, that is, when audio is a human voice, the tuning parameter may be adjusted so that the audio can be heard from the central portion 17a of the display 17 in the parameter region (see FIGS. 5 to 7). When a sound source is a musical instrument (such as a guitar), that is, when audio is a sound of the musical instrument, the tuning parameter may be adjusted so that the audio can be heard from an end portion of the display 17. Thus, the signal processing unit 14 tunes an audio signal based on the corresponding sound source.

Note that the tuning parameter may take on a value with surround sound taken into consideration. In other words, a plurality of the speakers 16 (a plurality of channels) may exist. In this case, the surround sound can be implemented by using the plurality of speakers 16. The tuning parameter is adjusted so that desired surround sound can be implemented.

In addition, virtual surround sound may be implemented by using the speaker 16. In this case, the tuning parameter is adjusted so that desired virtual surround sound can be implemented. Such processing enables the user to enjoy the surround sound at various placement angles. In other words, a surround sound effect is less likely to be influenced by the placement angle.

In the present embodiment, the tuning parameter as described above is set for the corresponding parameter region. In other words, as long as audio is outputted from the same sound source, the tuning parameter is adjusted so that the same sound field and the same sound quality can be reproduced for the parameter region.

(Modification of Tuning Parameter)

The tuning parameter is shared by sound sources in the example above, but may be prepared for each sound source. In this case, the tuning parameter has a value specially provided for the corresponding sound source. For example, when a sound source is a person, the tuning parameter is adjusted so that audio can be heard from in a more concentrated area which is the central portion of the display 17.

The signal processing unit 14 is a unit configured to tune an audio signal. Specifically, the signal processing unit 14 receives a detection signal from the sensor 12, and determines a current parameter region based on the detection signal.

Here, when the detection signal is changed (that is, when the placement angle of the speaker 16 is changed), the signal processing unit 14 may immediately determine the current parameter region. However, the parameter region of the speaker 16 might be changed frequently in a short time. For example, when the user changes the placement angle of the speaker 16 from the placement angle in FIG. 5 to the placement angle in FIG. 7 in a short time, the parameter region is changed frequently in the short time. This case leads to the corresponding tuning parameter frequently changed and thus to the sound field and quality of the audio frequently changed, and thus noise or the like might be generated. Hence, the signal processing unit 14 performs stable-state determination processing. As a matter of course, the stable-state determination processing does not have to be performed.

(Stable-State Determination Processing)

Specifically, when the detection signal is changed, the signal processing unit 14 waits until the detection signal becomes stable. When the detection signal becomes stable, the signal processing unit 14 determines a current parameter region based on the detection signal.

Subsequently, the signal processing unit 14 acquires a tuning parameter corresponding to the current parameter region from the storage unit 13, and tunes the audio signal based on the acquired tuning parameter. This leads to tuning of the frequency characteristic, the phase characteristic, and the like of the audio corresponding to the audio signal, and thus to tuning of the sound field and quality of the audio. As described above, even while being reproducing the audio signal, the signal processing unit 14 can dynamically switch the tuning parameters according to the current parameter region.

Here, when the tuning parameters vary with sound sources, the signal processing unit 14 identifies each sound source based on the corresponding audio signal, and acquires, from the storage unit 13, a tuning parameter to be used according to the identification result and the current parameter region. Then, the signal processing unit 14 tunes the audio signal based on the tuning parameter.

Subsequently, the signal processing unit 14 outputs the tuned audio signal to the audio circuit 15. The audio circuit 15 outputs audio corresponding to the audio signal from the speaker 16.

Accordingly, when being outputted from the same sound source, the audio outputted from the speaker 16 has the same sound field and the same sound quality regardless of the parameter region. FIGS. 5 to 7 illustrate an example of this effect. In this example, the audio is a human voice. As illustrated in FIGS. 5 to 7, when the audio is the human voice, the audio is heard from the central portion 17a of the display 17 regardless of the placement angle of the speaker 16.

In addition, the signal processing unit 14 outputs an image signal received from the signal acquisition unit 11, to the display 17. The display 17 displays an image corresponding to the image signal. The signal processing unit 14 also manages sound volume.

Note that the signal processing unit 14 can be implemented by hardware. When the signal processing unit 14 is implemented by hardware, the signal processing unit 14 may be included in the audio circuit 15. In addition, the user may select whether or not to perform processing of switching tuning parameters (that is, whether or not to use a sound-field tuning function).

In addition, when changing a tuning parameter, the signal processing unit 14 may stop outputting an audio signal yet to be tuned and then immediately start outputting a tuned audio signal. However, when the audio signals are switched, that is, when switching of a sound field and a sound quality of the audio is performed, this processing might cause discontinuous audio and thus noise such as turn on/off pops and clicks. Hence, when changing the tuning parameter, the signal processing unit 14 performs audio switching processing to be described later. As a matter of course, the audio switching processing does not have to be performed.

(Audio Switching Processing)

In the schematic description, the audio switching processing is processing of decreasing the sound volume of the audio signal yet to be tuned before the tuned audio signal is outputted to the audio circuit 15. Specifically, the audio switching processing is any of muting processing, fade-in/out processing, and cross-fade processing. The signal processing unit 14 may optionally select and perform any of the processing. The signal processing unit 14 may also select the audio switching processing according to a sound source and a situation (a situation where the display device 10 is placed).

(Muting Processing)

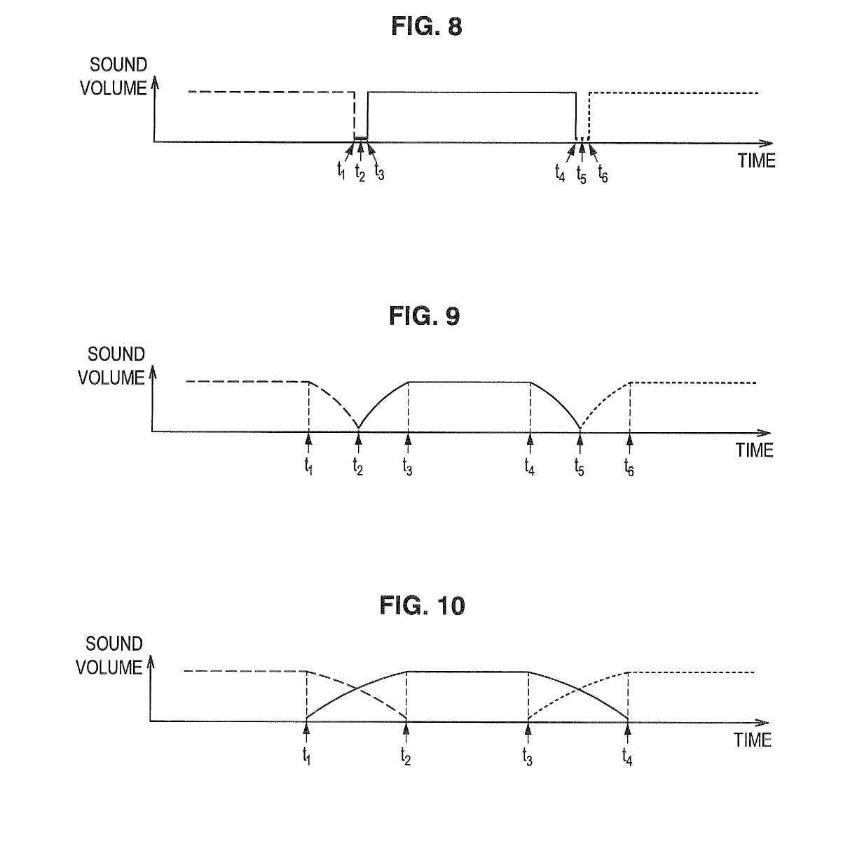

The muting processing is processing of: muting an audio signal yet to be tuned; tuning the audio signal; and then outputting the tuned audio signal to the audio circuit 15. An example of the muting processing will be described based on FIG. 8. FIG. 8 is a timing chart illustrating sound volume exhibited on the time basis. In the example in FIG. 8, the placement angle of the speaker 16 is the placement angle in FIG. 5 before time t₁, and the placement angle is changed to the placement angle in FIG. 6 at time t₁. Thereafter, the placement angle is maintained at the placement angle in FIG. 6 until time before time t₄. Then, the placement angle is changed to the placement angle in FIG. 7 at time t₄. Accordingly, the tuning region is changed at times t₁ and t₄.

In the example in FIG. 8, the signal processing unit 14 tunes an audio signal until time before time t₁ by using a tuning parameter appropriate for the placement angle in FIG. 5. Then, the signal processing unit 14 outputs the tuned audio signal to the audio circuit 15. The audio circuit 15 outputs audio corresponding to the audio signal from the speaker 16.

Thereafter, at time t₁, the sensor 12 detects change of the placement angle to the placement angle in FIG. 6, and outputs a detection signal indicating to that effect, to the signal processing unit 14. The signal processing unit 14 waits until the detection signal becomes stable. Thereafter, the signal processing unit 14 determines a current parameter region based on the detection signal. Then, the signal processing unit 14 requests the audio circuit 15 to mute the audio signal. The audio circuit 15 mutes the audio signal in response to this. That is, the audio circuit 15 mutes the audio signal yet to be tuned.

Subsequently, the signal processing unit 14 tunes the audio signal during the muting. Specifically, the signal processing unit 14 acquires a tuning parameter appropriate for the current parameter region (that is, appropriate for the placement angle in FIG. 6). Then, at time t₂, the signal processing unit 14 changes the tuning parameter and tunes the audio signal based on the changed tuning parameter. Then, at time t₃, the signal processing unit 14 requests the audio circuit 15 to cancel the muting and outputs the tuned audio signal to the audio circuit 15. The audio circuit 15 outputs audio corresponding to the audio signal from the speaker 16.

The signal processing unit 14 tunes the audio signal until time before time t₄ by using the tuning parameter appropriate for the placement angle in FIG. 6. Then, the signal processing unit 14 outputs the tuned audio signal to the audio circuit 15. The audio circuit 15 outputs the audio corresponding to the audio signal from the speaker 16.

Thereafter, at time t₄, the sensor 12 detects change of the placement angle to the placement angle in FIG. 7 and outputs a detection signal indicating to that effect, to the signal processing unit 14. Thereafter, between time t₄ and time t₆, the signal processing unit 14 performs the same processing as between time t₁ and time t₃. This causes audio tuned according to the placement angle in FIG. 7 to be outputted from the speaker 16 after time t₆.

As described above, when the parameter region is changed, the signal processing unit 14 mutes the audio signal only in a predetermined time period, and thus noise generation can be prevented. However, the user might not bear a sound break feeling. In this case, the signal processing unit 14 may perform the fade-in/out processing or the cross-fade processing to be described below.

(Fade-in/Out Processing)

The fade-in/out processing is processing in which fade-out of an audio signal yet to be tuned is started, the audio signal is tuned when the fade-out of is completed, and then fade-in of the tuned audio signal is started. An example of the fade-in/out processing will be described based on FIG. 9. FIG. 9 is a timing chart illustrating sound volume exhibited on the time basis. In the example in FIG. 9, the placement angle of the speaker 16 is the placement angle in FIG. 5 before time t₁, and the placement angle is changed to the placement angle in FIG. 6 at time t₁. Thereafter, the placement angle is maintained at the placement angle in FIG. 6 until time before time t₄. Then, the placement angle is changed to the placement angle in FIG. 7 at time t₄. Accordingly, the tuning region is changed at times t₁ and t₄.

In the example in FIG. 9, the signal processing unit 14 tunes the audio signal until time before time t₁ by using the tuning parameter appropriate for the placement angle in FIG. 5. Then, the signal processing unit 14 outputs the tuned audio signal to the audio circuit 15. The audio circuit 15 outputs audio corresponding to the audio signal from the speaker 16.

Thereafter, at time t₁, the sensor 12 detects change of the placement angle to the placement angle in FIG. 6 and outputs a detection signal to that effect, to the signal processing unit 14. The signal processing unit 14 waits until the detection signal becomes stable. Thereafter, the signal processing unit 14 determines a current parameter region based on the detection signal. Then, the signal processing unit 14 requests the audio circuit 15 to fade out the audio signal. The audio circuit 15 starts fading out the audio signal in response to this. That is, the audio circuit 15 starts fading out the audio signal yet to be tuned. In other words, the audio circuit 15 gradually decreases the sound volume of the audio outputted from the speaker 16, with the elapse of time.

Subsequently, the signal processing unit 14 acquires the tuning parameter appropriate for the current parameter region (that is, appropriate for the placement angle in FIG. 6). Then, at time t₂ when the fade-out is completed, the signal processing unit 14 changes the tuning parameter, and tunes the audio signal based on the changed tuning parameter. Then, the signal processing unit 14 requests the audio circuit 15 to fade in the audio signal and outputs the tuned audio signal to the audio circuit 15. The audio circuit 15 starts fading in the tuned audio signal. In other words, the audio circuit 15 gradually increases the sound volume of the audio outputted from the speaker 16, with the elapse of time. The fade-in is completed at time t₃.

The signal processing unit 14 tunes the audio signal until time before time t₄ by using the tuning parameter appropriate for the placement angle in FIG. 6. Then, the signal processing unit 14 outputs the tuned audio signal to the audio circuit 15. The audio circuit 15 outputs audio corresponding to the audio signal from the speaker 16.

Thereafter, at time t₄, the sensor 12 detects change of the placement angle to the placement angle in FIG. 7 and outputs a detection signal to that effect, to the signal processing unit 14. Thereafter, between time t₄ and time t₆, the signal processing unit 14 performs the same processing as between time t₁ and time t₃. This causes audio tuned according to the placement angle in FIG. 7 to be outputted from the speaker 16 after time t₆.

As described above, when the parameter region is changed, the signal processing unit 14 fades out and in the audio signal, and thus noise generation can be prevented more reliably. Moreover, the fade-in/out processing provides an effect in which the sound break feeling is reduced.

(Cross-Fade Processing)

The cross-fade processing is processing in which an audio signal is tuned, and then the audio signal yet to be tuned and the tuned audio signal are cross-faded. An example of the cross-fade processing will be described based on FIG. 10. FIG. 10 is a timing chart illustrating sound volume exhibited on the time basis. In the example in FIG. 10, the placement angle of the speaker 16 is the placement angle in FIG. 5 before time t₁, and the placement angle is changed to the placement angle in FIG. 6 at time t₁. Thereafter, the placement angle is maintained at the placement angle in FIG. 6 until time before time t₃. Then, the placement angle is changed to the placement angle in FIG. 7 at time t₃. Accordingly, the tuning region is changed at times t₁ and t₃.

In the example in FIG. 10, the signal processing unit 14 tunes the audio signal until time before time t₁ by using the tuning parameter appropriate for the placement angle in FIG. 5. Then, the signal processing unit 14 outputs the tuned audio signal to the audio circuit 15. The audio circuit 15 outputs audio corresponding to the audio signal from the speaker 16.

Thereafter, at time t₁, the sensor 12 detects change of the placement angle to the placement angle in FIG. 6 and outputs a detection signal to that effect, to the signal processing unit 14. The signal processing unit 14 waits until the detection signal becomes stable. Thereafter, the signal processing unit 14 determines a current parameter region based on the detection signal. Then, the signal processing unit 14 acquires the tuning parameter appropriate for the current parameter region (that is, appropriate for the placement angle in FIG. 6). Then, the signal processing unit 14 changes the tuning parameter and tunes the audio signal based on the changed tuning parameter.

Next, the signal processing unit 14 requests the audio circuit 15 to cross-fade the audio signal while outputting the audio signal yet to be tuned and the tuned audio signal to the audio circuit 15. The audio circuit 15 starts cross-fading the audio signal in response to this. That is, the audio circuit 15 starts fading out the audio signal yet to be tuned while starting fading in the tuned audio signal. In other words, the audio circuit 15 gradually decreases the sound volume of the audio corresponding to the audio signal yet to be tuned in the audio outputted from the speaker 16, with the elapse of time. Further, the audio circuit 15 gradually increases the sound volume of the audio corresponding to the tuned audio signal with the elapse of time. The cross-fade is completed at time t₂.

The signal processing unit 14 tunes the audio signal until time before time t₃ by using the tuning parameter appropriate for the placement angle in FIG. 6. Then, the signal processing unit 14 outputs the tuned audio signal to the audio circuit 15. The audio circuit 15 outputs audio corresponding to the audio signal from the speaker 16.

Thereafter, at time t₃, the sensor 12 detects change of the placement angle to the placement angle in FIG. 7 and outputs a detection signal to that effect, to the signal processing unit 14. Thereafter, between time t₃ and time t₄, the signal processing unit 14 performs the same processing as between time t₁ and time t₂. This causes the audio tuned according to the placement angle in FIG. 7 to be outputted from the speaker 16 after time t₄.

As described above, when the parameter region is changed, the signal processing unit 14 cross-fades the audio signal, and thus noise generation can be prevented more reliably. Moreover, the cross-fade processing provides an effect in which the sound break feeling is reduced to a larger degree than the fade-in/out processing. However, the cross-fade processing might cause the user to feel audio mixing. Hence, the signal processing unit 14 may cause the user to select one of the audio switching processing. The signal processing unit 14 may also select one of the audio switching processing according to a sound source or a situation (a situation where the display device 10 is placed). By performing the audio switching processing, the signal processing unit 14 can prevent audio grade deterioration at the time of switching the tuning parameters.

<3. Steps of Processing by Display Device>

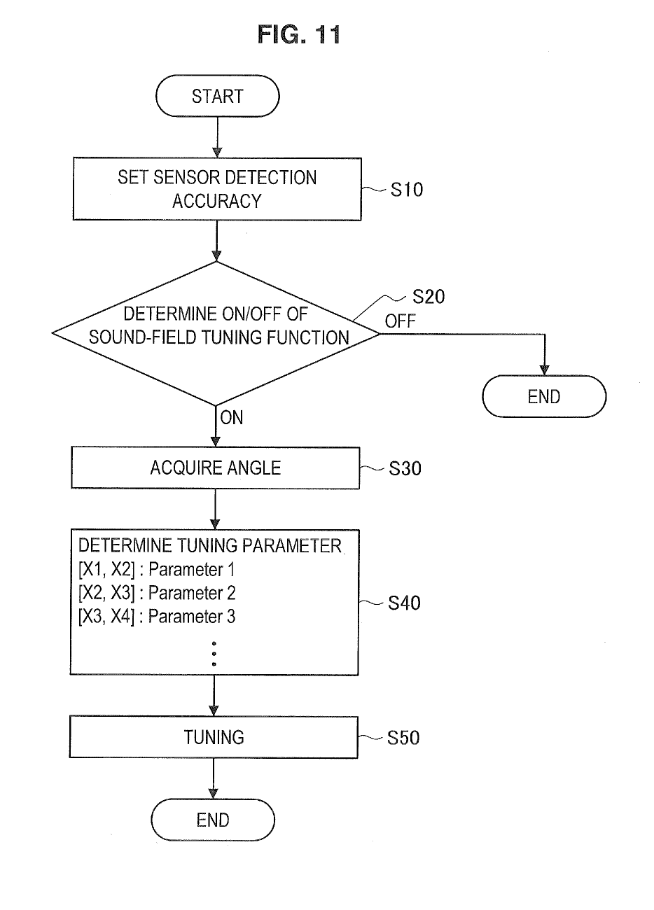

Next, steps of processing performed by the display device 10 will be described by using flowcharts in FIGS. 11 to 13.

(Processing in Starting Display Device)

Firstly, processing in starting the display device 10 will be described based on FIG. 11. When being turned on, the display device 10 performs processing in FIG. 11.

In Step S10, the signal processing unit 14 sets the detection accuracy of the sensor 12. In Step S20, the signal processing unit 14 determines whether or not the user has turned on a sound-field tuning function (that is, a function of changing a tuning parameter according to a parameter region). When the sound-field tuning function is on, the signal processing unit 14 proceeds to Step S30. When determining that the sound-field tuning function is off, the signal processing unit 14 terminates the processing.

In Step S30, the signal processing unit 14 receives a detection signal from the sensor 12 and determines a current parameter region (that is, a placement angle) based on the detection signal. In Step S40, the signal processing unit 14 acquires a tuning parameter appropriate for the current parameter region from the storage unit 13.

In Step S50, the signal processing unit 14 tunes an audio signal based on the tuning parameter. Subsequently, the signal processing unit 14 outputs the tuned audio signal to the audio circuit 15. The audio circuit 15 outputs audio corresponding to the audio signal from the speaker 16. Thus, the signal processing unit 14 can tune the audio signal according to the current parameter region.

(Processing in Switching Settings)

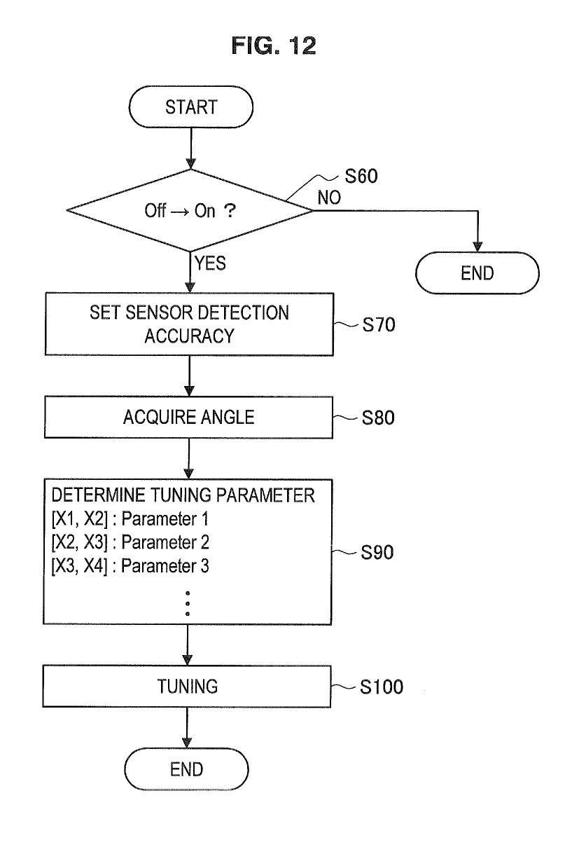

Next, processing in switching turning on and off of the sound-field tuning function will be described based on FIG. 12.

In Step S60, the signal processing unit 14 determines whether or not a state of the sound-field tuning function is changed from an off state to an on state. When determining the off state of the sound-field tuning function is changed to the on state, the signal processing unit 14 proceeds to Step S70. When the on state of the sound-field tuning function is changed to the off state, the signal processing unit 14 terminates the processing.

In Steps S70 to S100, the signal processing unit 14 performs the same processing as in Steps S10 and S30 to S50 in FIG. 11. Thus, when the off state of the sound-field tuning function is changed to the on state, the signal processing unit 14 can tune the audio signal according to the current parameter region.

(Sound-Field Tuning Processing)

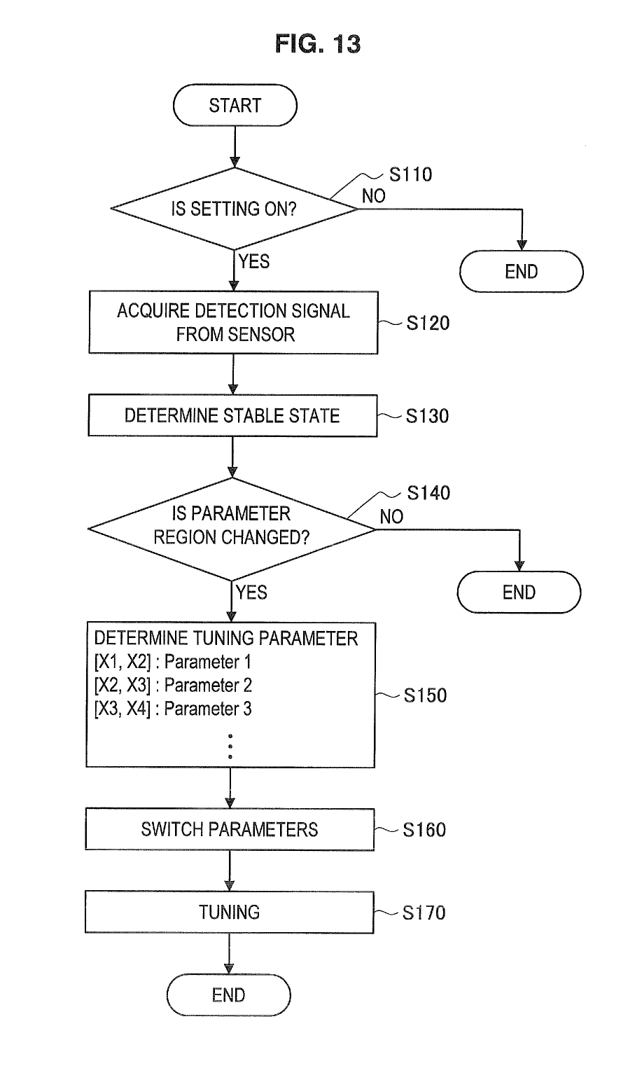

Next, sound-field tuning processing which is tuning processing appropriate for a parameter region will be described based on FIG. 13. Note that a case of the fade-in/out processing is described below, but the muting processing or the cross-fade processing may be performed, as a matter of course.

In Step S110, the signal processing unit 14 determines whether or not the sound-field tuning function is on. When determining that the sound-field tuning function is on, the signal processing unit 14 proceeds to Step S120. When, determining that the sound-field tuning function is off, the signal processing unit 14 terminates the processing.

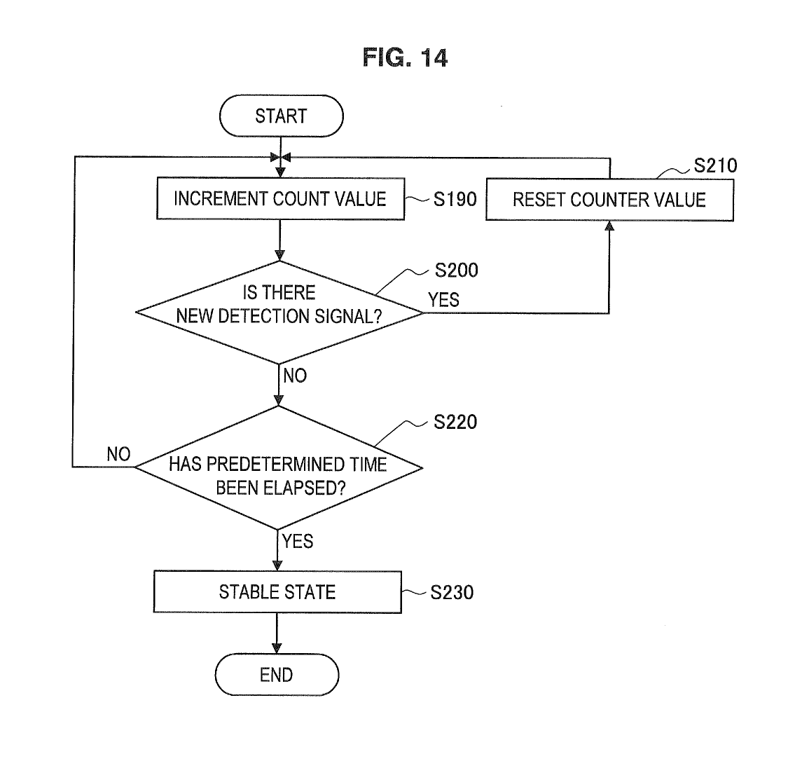

In Step S120, the signal processing unit 14 acquires a detection signal from the sensor 12. In Step S130, the signal processing unit 14 performs the stable-state determination processing in FIG. 14. This causes the signal processing unit 14 to wait until the detection signal becomes stable, that is, until an environment allowing the user to use the display device 10 is established.

In Step S140, the signal processing unit 14 determines whether or not the parameter region is changed before or after the stable-state determination processing. When determining that the parameter region is changed, the signal processing unit 14 proceeds to Step S150. When determining that the parameter region is not changed, the signal processing unit 14 terminates the processing.

In Step S150, the signal processing unit 14 requests the audio circuit 15 to fade out the audio signal. The audio circuit 15 starts fading out the audio signal in response to this. That is, the audio circuit 15 starts fading out the audio signal yet to be tuned. In other words, the audio circuit 15 gradually decreases the sound volume of audio outputted from the speaker 16, with the elapse of time. Then, the signal processing unit 14 acquires a tuning parameter appropriate for a current parameter region.

In Step S160, the signal processing unit 14 waits until the fade-out is completed, and changes the tuning parameter when the fade-out is completed. In Step S170, the signal processing unit 14 tunes the audio signal based on the changed tuning parameter.

Then, the signal processing unit 14 requests the audio circuit 15 to fade in the audio signal and outputs the tuned audio signal to the audio circuit 15. The audio circuit 15 starts the fade-in of the tuned audio signal. That is, the audio circuit 15 gradually increases the sound volume of the audio outputted from the speaker 16, with the elapse of time. Thereafter, the signal processing unit 14 terminates the processing. As described above, even while being reproducing the audio signal, the signal processing unit 14 can dynamically switch the tuning parameters according to the current parameter region. Thus, even if the placement angle of the speaker 16 is changed while the audio signal is being reproduced, the signal processing unit 14 can prevent change of the sound field, the sound quality, and a surround sound effect.

(Stable-State Determination Processing)

Next, the stable-state determination processing will be described based on FIG. 14. In Step S190, the signal processing unit 14 increments a count value (the count value is stored in the storage unit 13, for example) by a predetermined value (for example, 1).

In Step S200, the signal processing unit 14 acquires the detection signal from the sensor 12 and determines whether or not the parameter region is changed (that is, whether or not a new detection signal is received) based on the detection signal. When determining that the parameter region is changed, the signal processing unit 14 proceeds to Step S210. When determining that the parameter region is not changed, the signal processing unit 14 proceeds to Step S220.

In Step S210, the signal processing unit 14 resets the count value to zero. Then, the signal processing unit 14 moves back to Step S190. In Step S220, the signal processing unit 14 determines whether or not a predetermined time elapses, based on the count value. When determining that the predetermined time elapses, the signal processing unit 14 proceeds to Step S230. When determining that the predetermined time does not elapse, the signal processing unit 14 moves back to Step S190.

In Step S230, the signal processing unit 14 determines that the detection signal becomes stable, that is, that the current environment changes to the environment allowing the user to use the display device 10. Thereafter, the signal processing unit 14 proceeds to Step S140 in FIG. 13.

According to the present embodiments as described above, the display device 10 tunes the audio signal to be outputted to the speaker 16, based on the placement angle of the speaker 16 (usage state). This enables the display device 10 to tune the audio signal according to the placement angle of the speaker 16 and to output the audio having the more stable sound field and quality.

Further, the display device 10 tunes the audio signal based on the corresponding sound source of the audio signal and thus can output the audio having the sound field and quality appropriate for the sound source.

Here, each tuning parameter may be shared by the sound sources. In this case, the tuning parameter is used for setting the sound field and quality for each sound source. Then, the display device 10 corrects the tuning parameter based on the placement angle of the speaker 16 and tunes the audio signal based on the corrected tuning parameter. Thus, the display device 10 can output the audio having the sound field and quality appropriate for the sound source.

In addition, the tuning parameters may vary with the sound sources. In this case, the display device 10 identifies each sound source and tunes the audio signal based on the tuning parameter among the tuning parameters which is to be used according to the identification result. Thus, the display device 10 can output the audio having the sound field and quality specially provided for the sound source.

In addition, when the placement angle of the speaker 16 is changed, the display device 10 tunes the audio signal based on the changed placement angle. Thus, even though the placement angle of the speaker 16 is changed, the display device 10 can prevent change of the sound field and quality.

In addition, the display device 10 performs the audio switching processing, and thus a possibility of noise generation at the time of switching the tuning parameters can be reduced.

In addition, the display device 10 may perform the muting processing as the audio switching processing. In this case, the possibility of noise generation at the time of switching the tuning parameters can be reduced.

In addition, the display device 10 may perform the fade-in/out processing as the audio switching processing. In this case, the possibility of noise generation at the time of switching the tuning parameters can be reduced. Further, the display device 10 can reduce the sound break feeling.

In addition, the display device 10 may perform the cross-fade processing as the audio switching processing. In this case, the possibility of noise generation at the time of switching the tuning parameters can be reduced. Further, the display device 10 can further reduce the sound break feeling.

In addition, the display device 10 may perform the stable-state determination processing. In this case, a possibility of noise generation at the time of changing the placement angle can be reduced.

It should be understood by those skilled in the art that various modifications, combinations, sub-combinations and alterations may occur depending on design requirements and other factors insofar as they are within the scope of the appended claims or the equivalents thereof.

For example, the placement angle is used for the usage state in the aforementioned embodiments, the embodiments of the present technology are not limited to the example. For example, the audio signal may be tuned after determining the usage state by detecting: a placement direction; or a position or an orientation of the user detected by a camera or the like. Moreover, the display device is described as an example of the information processing apparatus according to an embodiment of the present disclosure, but the information processing apparatus is not limited to the example. The information processing apparatus may be the speaker alone, for example. Further, the position where the speaker is placed is not limited to the lower part of the rear surface of the display.

Additionally, the present disclosure may also be configured as below.

(1) An information processing apparatus including:

a detection unit configured to detect a usage state of a sound output unit; and

a signal processing unit configured to tune sound signals to be outputted to the sound output unit, based on the usage state of the sound output unit.

(2) The information processing apparatus according to (1),

wherein the signal processing unit tunes the sound signals based on sound sources of the sound signals.

(3) The information processing apparatus according to (2),

wherein the signal processing unit acquires a correction parameter which is shared by the sound sources and used for setting at least one of a sound field and a sound quality for each of the sound sources, corrects the correction parameter based on the usage state of the sound output unit, and tunes each sound signal based on the corrected correction parameter.

(4) The information processing apparatus according to (2),

wherein the signal processing unit identifies each of the sound sources and tunes the corresponding sound signal based on a correction parameter to be used according to an identification result, the correction parameter being one of correction parameters which vary with the sound sources and which are each used for setting at least one of a sound field and a sound quality.

(5) The information processing apparatus according to any one of (1) to (4),

wherein when the usage state of the sound output unit is changed, the signal processing unit tunes each of the sound signals based on the changed usage state.

(6) The information processing apparatus according to (5),

wherein when the usage state of the sound output unit is changed, the signal processing unit performs sound switching processing before outputting the tuned sound signal, the sound switching processing decreasing sound volume of the sound signal yet to be tuned.

(7) The information processing apparatus according to (6),

wherein the signal processing unit performs, as the sound switching processing, processing of muting the sound signal yet to be tuned, tuning the sound signal while muting the sound signal, and then causing the sound output unit to output the tuned sound signal.

(8) The information processing apparatus according to (6),

wherein the signal processing unit performs, as the sound switching processing, processing of starting fade-out of the sound signal yet to be tuned, tuning the sound signal upon completion of the fade-out, and then starting fade-in of the tuned sound signal.

(9) The information processing apparatus according to (6),

wherein the signal processing unit performs, as the sound switching processing, processing of tuning the sound signal and then cross-fading the sound signal yet to be tuned and the tuned sound signal.

(10) The information processing apparatus according to any one of (5) to (9),

wherein when the usage state of the sound output unit is changed, the signal processing unit waits until the usage state of the sound output unit becomes stable, and when the usage state of the sound output unit becomes stable, the signal processing unit tunes the sound signal.

(11) An information processing method including:

detecting a usage state of a sound output unit; and

tuning a sound signal to be outputted to the sound output unit, based on the usage state of the sound output unit.

(12) A program causing a computer to implement:

a detection function of detecting a usage state of a sound output unit; and

a signal processing function of tuning the sound signal to be outputted to the sound output unit, based on the usage state of the sound output unit.

What is claimed is:

1. An information processing apparatus comprising:
a detection unit configured to detect a usage state of a sound output unit; and
a signal processing unit configured to tune sound signals to be outputted to the sound output unit, based on the usage state of the sound output unit.

2. The information processing apparatus according to claim 1,
wherein the signal processing unit tunes the sound signals based on sound sources of the sound signals.

3. The information processing apparatus according to claim 2,
wherein the signal processing unit acquires a correction parameter which is shared by the sound sources and used for setting at least one of a sound field and a sound quality for each of the sound sources, corrects the correction parameter based on the usage state of the sound output unit, and tunes each sound signal based on the corrected correction parameter.

4. The information processing apparatus according to claim 2,
wherein the signal processing unit identifies each of the sound sources and tunes the corresponding sound signal based on a correction parameter to be used according to an identification result, the correction parameter being one of correction parameters which vary with the sound sources and which are each used for setting at least one of a sound field and a sound quality.

5. The information processing apparatus according to claim 1,
wherein when the usage state of the sound output unit is changed, the signal processing unit tunes each of the sound signals based on the changed usage state.

6. The information processing apparatus according to claim 5,
wherein when the usage state of the sound output unit is changed, the signal processing unit performs sound switching processing before outputting the tuned sound signal, the sound switching processing decreasing sound volume of the sound signal yet to be tuned.

7. The information processing apparatus according to claim 6,
wherein the signal processing unit performs, as the sound switching processing, processing of muting the sound signal yet to be tuned, tuning the sound signal while muting the sound signal, and then causing the sound output unit to output the tuned sound signal.

8. The information processing apparatus according to claim 6,
wherein the signal processing unit performs, as the sound switching processing, processing of starting fade-out of the sound signal yet to be tuned, tuning the sound signal upon completion of the fade-out, and then starting fade-in of the tuned sound signal.

9. The information processing apparatus according to claim 6,
wherein the signal processing unit performs, as the sound switching processing, processing of tuning the sound signal and then cross-fading the sound signal yet to be tuned and the tuned sound signal.

10. The information processing apparatus according to claim 5,
wherein when the usage state of the sound output unit is changed, the signal processing unit waits until the usage state of the sound output unit becomes stable, and when the usage state of the sound output unit becomes stable, the signal processing unit tunes the sound signal.

11. An information processing method comprising:
detecting a usage state of a sound output unit; and
tuning a sound signal to be outputted to the sound output unit, based on the usage state of the sound output unit.

12. A program causing a computer to implement:
a detection function of detecting a usage state of a sound output unit; and
a signal processing function of tuning the sound signal to be outputted to the sound output unit, based on the usage state of the sound output unit.
